(19) United States
(12) Patent Application Publication
(10) Pub. No.: US 2026/0265051 A1
(43) Pub. Date: Sep. 10, 2026

(54) METHOD FOR PRODUCING LOW-CARBON HYDROGEN AND PLANT FOR THE IMPLEMENTATION THEREOF

(71) Applicant: Publichnoe Aktsionernoe Obshchestvo "NOVATEK", Tarko-Sale (RU)

(72) Inventors: Sergei Vladimirovich RUDENKO, Moscow (RU); Pavel Olegovich FEDOSEEV, Moscow (RU); Timir Emilevich RAZIAPOV, Moscow (RU); Aleksei Ivanovich TSEPKOV, Moscow (RU); Dmitrii Nikolaevich SEDAVNYKH, Moscow (RU); Stanislav Aleksandrovich NIKULIN, Moscow (RU)

(73) Assignee: Publichnoe Aktsionernoe Obshchestvo "NOVATEK", Tarko-Sale (RU)

(21) Appl. No.: 19/472,124

(22) PCT Filed: Jan. 12, 2024
(86) PCT No.: PCT/RU2024/000008

§ 371 Date: Oct. 3, 2025

(30) Foreign Application Priority Data
Jul. 13, 2023 (RU) 2023118596

(51) Int. Cl. C01B 3/047; B01J 6/00; C01B 3/501; C01B 3/56

(52) U.S. Cl. CPC C01B 3/047; B01J 6/008; C01B 3/501; C01B 3/56; C01B 2203/0405; C01B 2203/042; C01B 2203/0822; C01B 2203/0833; C01B 2203/0883

(57) ABSTRACT

In a method for producing low-carbon hydrogen from ammonia and a plant implementing the method, liquid ammonia feedstock is heated and superheated in a heat-reclaiming module coil and supplied into an ammonia cracking reactor, the resulting nitrogen-hydrogen mixture is cooled in an air cooler, and hydrogen is recovered. The liquid ammonia fuel is heated and evaporated, the gaseous ammonia fuel is superheated and mixed with tail gases resulting from the hydrogen recovery, and the resulting fuel gas, together with hot air, is supplied to the ammonia cracking reactor. The ammonia feedstock and the ammonia fuel are evaporated and superheated in respective recuperative heat exchangers. An outlet for the flue gases of the ammonia cracking reactor is connected to the heat-reclaiming module. Extraction of distilled water from the flue gases as a by-product becomes possible by cooling the exiting flue gases to approx. +60° C. in the heat-reclaiming module.

### TECHNICAL FIELD

The invention pertains to technologies for production of low-carbon hydrogen from ammonia through ammonia cracking for further use of low-carbon hydrogen as carbon-neutral fuel or low-carbon hydrogen compression for transmission via mainline fuel systems to end users.

### BACKGROUND ART

There exist multiple well-known methods for producing hydrogen through ammonia cracking, involving use of fuel, which generates carbon dioxide when combusted.

The dfeedback of such methods and plants is that when cracking ammonia using fuel, which generates carbon dioxide when combusted, carbon dioxide is emitted into the atmosphere.

There also exist methods for producing low-carbon hydrogen through ammonia cracking that use ammonia and a mixture of nitrogen and hydrogen as fuel, which do not generate any carbon dioxide when combusted (WO2021/257944A1, publication date: Dec. 23, 2021; WO2022/265648A1, publication date: Dec. 22, 2022, WO2021/265651A1, publication date: Dec. 22, 2022, CN111137853A, publication date: May 12, 2020, CN111957270A, publication date: Nov. 20, 2020).

A method, which is the closest to the proposed one, features production of low-carbon hydrogen through ammonia cracking where liquid ammonia feedstock is separated into ammonia fuel and ammonia feedstock and pressurized by two pumps, then the liquid ammonia feedstock is heated, evaporated and superheated in a heat exchanger to more than 250° C. by recovering the waste heat from flue gases and the mixture of nitrogen and hydrogen (NHM), then the superheated gaseous ammonia is fed into the ammonia cracking reactor where ammonia is decomposed into nitrogen and hydrogen in an endothermic reaction, for the normal occurrence of which the heat from the combustion of carbon-neutral fuel gas (a mixture of ammonia fuel and flue gases from the pressure swing adsorption (PSA) unit) is used as the energy source. Downstream the reactor, the mixture of nitrogen and hydrogen with residual ammonia content is supplied (preferably, through an air cooler) to the PSA unit to recover hydrogen, while the flue gases downstream the heat exchanger are vented. While the dfeedings depict a single heat exchanger, real-life applications use a series of heat exchangers. A different heat source, such as water or ambient air, may be used for pre-heating and evaporation of the compressed ammonia feedstock (WO2021/265649A1, publication date: Dec. 22, 2022).

A plant for implementation of the above mentioned method, which is the closest to the proposed one, comprises a heat exchanger (or a series of heat exchangers), an ammonia cracking reactor, a ammonia feedstock line, a ammonia fuel line, an air supply line, a nitrogen and hydrogen mixture line (NHM), and a flue gas line. The ammonia feedstock line connects in series a liquid ammonia feedstock pump, the first heat exchange space of the heat exchanger (or a series of heat exchangers), and a pipeline that supplies the superheated ammonia to the reactor. The ammonia fuel line connects in series a liquid ammonia fuel pump, the second heat exchange space of the heat exchanger, a mixer, and a reactor furnace. The air supply line comprises a compressor, the third heat exchange space of the heat exchanger, and a reactor furnace. The NHM line comprises the fourth heat exchange space of the heat exchanger, an air cooler, a pressure swing adsorption (PSA) unit, an off gas pipeline for gases that are not the target product of the PSA unit, the fifth heat exchange space of the heat exchanger, a mixer, and a reactor furnace. A no-mixer option is possible where the components are supplied to the reactor furnace for combustion as individual streams. The PSA unit has connections to a hydrogen discharge line and the flue gas line, which comprises the sixth heat exchange space of the heat exchanger and the flue gas discharge pipeline (WO2021/265649A1, publication date: Dec. 22, 2022).

The known method and plant feature the following dfeedbacks. The flue gases cooled in the multi-stream heat exchanger are so hot that the use of the flue gas extractor to send it for further processing leads to a higher energy consumption since the volumetric flow rate of flue gases is higher when they are hot. In other words, at a constant mass flow rate, the hotter the gas occupies the more volume, thus requiring more energy to transfer it.

Furthermore, the use of multi-stream heat exchangers that feature phase transformation (evaporation of ammonia feedstock and ammonia fuel) can cause high vibration loads and undermine the overall process reliability.

### Essence of the Invention

The technical problem, which is solved with the proposed low-carbon hydrogen technology, is the improvement of the low-carbon hydrogen process overall efficiency and the capability to produce distilled water as a by-product.

The technical problem is solved with a method for producing hydrogen from ammonia, which consists in pressurizing liquid ammonia, heating and evaporating liquid ammonia feedstock, superheating gaseous ammonia feedstock, which is supplied to an ammonia cracking reactor, cooling a mixture of nitrogen and hydrogen resulting from the ammonia cracking and recovering hydrogen from the mixture, heating and evaporating ammonia fuel, superheating gaseous ammonia fuel, mixing it with tail gases resulting from the hydrogen recovery, and supplying the resulting fuel gas, together with hot air, to the ammonia cracking reactor for combustion, utilizing the heat from flue gases to increase the temperature of the ammonia feedstock as well as air and fuel gas, according to the invention, pairing the ammonia cracking reactor with a heat-reclaiming equipment unit (HRE) that utilizes the heat from flue gases, using the heat from flue gases to increase the temperature of the liquid ammonia feedstock upstream a HRE flue gas outlet, then pressurizing and cooling the utilized flue gases, extracting the distilled water condensed from the flue gases, and venting the dewatered flue gases.

Besides, the ammonia feedstock is evaporated and superheated in respective recuperative heat exchangers utilizing the heat from the mixture of nitrogen and hydrogen, and the gaseous ammonia feedstock is then heated using the heat from the flue gases.

Besides, the ammonia fuel is evaporated and superheated in other respective recuperative heat exchangers using a heating medium that utilizes the heat from the flue gases.

Hydrogen recovery from the mixture of nitrogen and hydrogen can be achieved through pressure swing adsorption.

Another hydrogen recovery option is memebrane extraction.

The preferable option is separation of the ammonia stream into the liquid ammonia feedstock and the liquid ammonia fuel after the liquid ammonia pressurization.

Adding some of the gaseous ammonia fuel to the flue gases supplied to a shell side of the HRE to neutralize nitrogen oxides is also advisable.

The technical problem is also solved with a plant that produces hydrogen from ammonia comprising a liquid ammonia pump, a ammonia feedstock heating line, a ammonia fuel heating line, an ammonia cracking reactor paired with a heat-reclaiming equipment unit (HRE), an air heating line and a purification line; the ammonia feedstock heating line comprises a HRE liquid ammonia feedstock heating coil, the first recuperative heat exchanger-a ammonia feedstock evaporator, the second recuperative heat exchanger-a ammonia feedstock superheater, and a HRE gaseous ammonia feedstock heating coil, and the ammonia feedstock heating line is connected to reaction tubes of the ammonia cracking reactor; the ammonia fuel heating line comprises the third recuperative heat exchanger-a liquid ammonia fuel heater and the fourth recuperative heat exchanger-a ammonia fuel evaporator, which is connected to a HRE gaseous ammonia fuel heating coil connected to an ammonia cracking reactor burner; outlets of the reaction tubes are connected to the second and the first recuperative heat exchangers as well as to the purification line that comprises at least one air cooler and a hydrogen recovery unit, which has a tail gas outlet that is connected to the ammonia fuel heating line upstream the HRE gaseous ammonia fuel heating coil; the air heating line comprises an air supplier and a HRE air heating coil, which is connected to the ammonia cracking reactor burner, moreover, the HRE liquid ammonia feedstock heating coil is upstream a HRE flue gas outlet, which is connected in series to a flue gas extractor, at least one other air cooler, and a distilled water separator.

Besides, the third recuperative heat exchanger-a liquid fue lammonia heater) and the fourth recuperative heat exchanger a ammonia fuel evaporator are connected in parallel into a heating medium circuit, which comprises a HRE heating medium heating coil connected to these heat exchangers, and a heating medium circulation pump.

Shell and tube heat exchangers are preferable as recuperative heat exchangers.

One of the options for the hydrogen recovery unit is a pressure swing adsorption unit.

Another option for the hydrogen recovery unit is a membrane hydrogen recovery unit.

Parallel connection to a liquid ammonia pump outlet is advisable for the ammonia feedstock and ammonia fuel heating lines.

A flue gas branch pipe connecting to a HRE shell side is also advisable for the ammonia fuel heating line.

The technical result of the proposed method and plant consists in enabling the extraction of distilled water from flue gases as a by-product by cooling the exiting flue gases to approx. +60 degC in the heat-reclaiming equipment unit.

### LIST OF DRAWINGS

FIG. 1 shows the layout of the proposed plant.

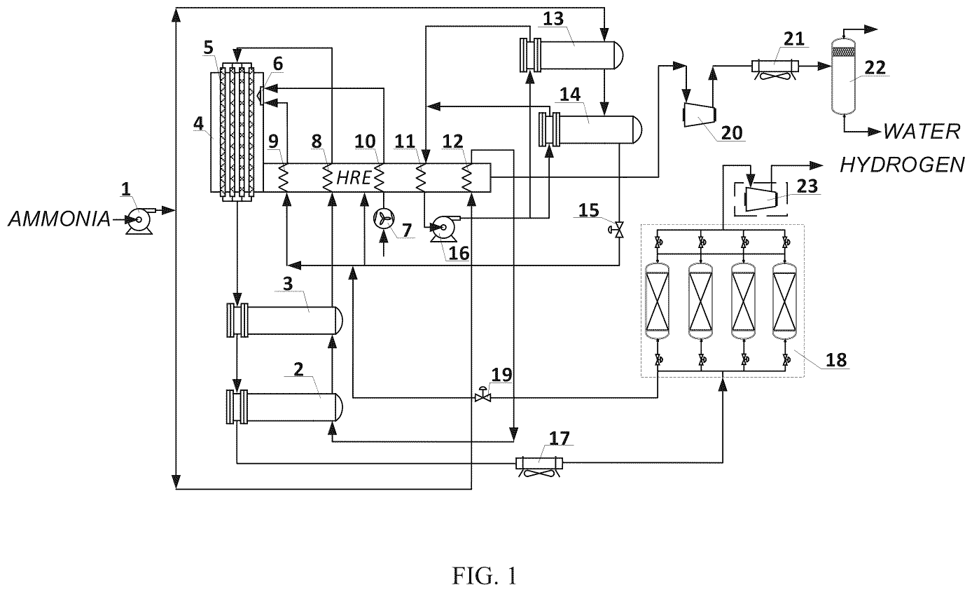

### EXAMPLES OF IMPLEMENTATION OF THE INVENTION

The plant for producing low-carbon hydrogen comprises a liquid ammonia feedstock heating line, an ammonia cracking reactor paired with a HRE (heat-reclaiming equipment unit), a ammonia fuel heating line, an air heating line, a purification line, and a water condensation line.

The liquid ammonia feedstock heating line comprises connected in series liquid ammonia pump 1, HRE coil 12, recuperative heat exchanger (liquid ammonia evaporator) 2, recuperative heat exchanger (gaseous ammonia superheater) 3, and HRE coil 8.

Ammonia cracking reactor 4 with reaction tubes 5 comprises nitrogen-hydrogen burner 6. The air heating line comprises air blower 7 and HRE coil 9, which is connected to burner 6. The HRE is connected to the flue gas outlet of reactor 4 and houses, in a series layout, gaseous ammonia heating coil 8, ammonia fuel heating coil 9, air heating coil 10, heating medium heating coil 11, and liquid ammonia heating coil 12 upstream the HRE flue gas outlet.

The ammonia fuel heating line connects in series third recuperative heat exchanger (liquid ammonia fuel heater) 13 and fourth recuperative heat exchanger (liquid ammonia fuel evaporator) 14, and pressure reducer 15. Heater 13 and evaporator 14 are part of the heating medium (preferably, oil) circuit, which comprises HRE coil 11 connected to heater 13 and evaporator 14, and heating medium circulation pump 16.

The purification line comprises air cooler(s) 17, pressure swing adsorption (PSA) hydrogen recovery unit 18, and off-gas pressure reducer 19 for tail gases that are not the target product of PSA unit 18. The purification line and the ammonia fuel heating line form a single line connected to HRE coil 9. Compressor 23 is an extra design option to compress the low-carbon hydrogen downstream PSA unit 18 if it needs to be transmitted over a long distance.

As an alternative plant design, the purification line comprises, downstream air cooler(s) 17, at least one nitrogen-hydrogen compressor and at least one air cooler to relief the compression heat, as well as a membrane hydrogen recovery unit (not shown on the drawing) instead of the PSA unit, which, in turn, enables production of market-grade high-pressure low-carbon hydrogen, making low-carbon hydrogen compressor 23 redundant.

Ahead of an interface with the purification line, the ammonia fuel heating line has a branch pipe connected to a HRE shell side.

The water condensation line comprises air cooler(s) 21 connected to the HRE outlet, and separator 22 to generate distilled water and dewatered flue gases.

The proposed drive for liquid ammonia pump 1, heating medium circulation pump 16 and low-carbon hydrogen compressor 23 is electric motors powered by a wind power plant, but this is not the only drive option. Any carbon-neutral or “green” electricity sources or gas turbine engines could serve as the power source.

The method for producing low-carbon hydrogen from ammonia is implemented as follows.

Liquid ammonia is supplied to liquid ammonia pump 1 where it is pressurized to approx. 2.5-4.0 MPa and then separated into ammonia fuel and ammonia feedstock at a ratio of 5-10 %/90-95 %, respectively. The liquid ammonia feedstock is then heated almost to ammonia boiling point at the respective pressure with a 2-10 degC margin lower from the temperature of the beginning of ammonia boiling by utilizing the heat recovered from flue gases in heat recovery unit coil 12, then liquid ammonia feedstock is evaporated in evaporator 2 and superheated by 2-10 degC by utilizing heat from the mixture of nitrogen and hydrogen, whereafter the gaseous ammonia feedstock is superheated to approx. +360 degC by utilizing the heat from the mixture of nitrogen and hydrogen (NHM) in superheater 3. The superheated gaseous ammonia is then supplied to HRE coil 8 and heated to approx. +400 degC, and sent to reaction tubes 5 of ammonia cracking reactor 4 where ammonia is decomposed into nitrogen and hydrogen in endothermic reaction at approx. 2-3.5 MPa and approx. +450-1,000 degC. For the normal occurrence of the reaction, the heat from the combustion of fuel gas is used as the energy source. The suitable catalysts are chosen from, but are not limited to: Ru/Al₂O₃, Ni/Al₂O₃, Ru/CeO₂, Ni/CeO₂.

Downstream ammonia cracking reactor 4, the mixture of nitrogen and hydrogen with a residual ammonia content of approx. 0.9 mol. % at approx. 2-3.5 MPa and approx. +450-1,000 degC is supplied to the recuperative heat exchangers system (superheater 3, evaporator 2) and air cooler 17 where it is cooled to approx. +35 degC through heat transfer to the ammonia feedstock and ambient air, and then sent to PSA unit 18 (or the membrane hydrogen recovery unit) for recovery of hydrogen with a purity of 99.97 mass %.

Tail gases from PSA unit 18 containing nitrogen, hydrogen, and ammonia, are throttled to approx. 0.16 MPaG with the help of pressure reducer 19 and sent to mixing with gaseous ammonia fuel upstream HRE coil 9. The liquid ammonia fuel is supplied to heat exchanger 13 where it is heated with a 2-10 degC margin lower from the temperature of the beginning of ammonia boiling at the respective pressure by an oil-type heating medium, then evaporated in evaporator 14 and superheated by 2-10 degC by an oil-type heating medium, and exits with a temperature of approx. +76 degC. The superheated ammonia fuel is then throttled in stages to 0.16 MPaG with the help of pressure reducer 15 and mixed with the tail gases from PSA unit 18 upstream HRE coil 9. Then, as it passes through coil 9, the fuel gas is heated to approx. +600 degC and supplied to burner 6 to release the energy required for the normal occurrence of the endothermic ammonia cracking reaction.

Air blower 7 feeds the ambient air to HRE coil 10 for heating to approx. +300 degC. The air is then sent to burner 6 for the combustion of the carbon-neutral fuel, primarily comprising (without limitation) ammonia, nitrogen, hydrogen, and traces of water. The heating medium (for example, oil) at approx. 50 kPaG and approx. +190 degC is supplied to heating medium circulation pump 16 and pressurized to the heating medium circuit operating pressure, and then sent in parallel to heater 13 and evaporator 14 at a ratio of approx. 34 %/66 %, respectively, where it is cooled to approx. +170 degC, whereafter it is sent to HRE coil 11 for re-heating to approx. +190 degC.

Flue gases from ammonia cracking reactor 4 at approx. +450 to +1,000 degC are supplied to the HRE shell side, cooled to approx. +60 degC passing through coil 8, then coil 9, then coil 10, then coil 11, then coil 12, and, with the help of flue gas extractor 20 sent to air cooler 21 for water condensation, whereafter the condensed distilled water is extracted in separator 22. Downstream separator 22, the flues gases, consisting of nitrogen, residual water, and air impurities, are vented, while the trace quantities of NOx are neutralized by supplying the gaseous ammonia fuel to the HRE shell side, thus making the process carbon-neutral or low-carbon.

Unlike the prototype, through condensation at air cooler 21, flue gases are used to generate a by-product, distilled water, which generates as result of the combustion of carbon-neutral fuel. The greater heat transfer from the flue gases to the liquid ammonia feedstock in HRE coil 12 with the flue gases cooling down to approx. +60 C enables the production of distilled water as a by-product, by pressurizing the flue gases in the flue gas extractor and condensing water from them through ambient cooling. In the prototype, heat recovery results in a higher temperature, meaning that the use of the flue gas extractors with higher inlet and outlet temperatures would result in a higher energy consumption since the volumetric flow rate of flue gases is higher when they are hot. In other words, at a constant mass flow rate, the hotter the gas gets, the more volume it occupies, thus requiring more energy to transfer it. Unlike the prototype, the liquid ammonia treatment in the proposed method and plant occurs in stages: the ammonia feedstock is heated in HRE coil 12 utilizing the heat from the flue gases, then evaporated in a separate heat exchanger 2 using the heat from the mixture of nitrogen and hydrogen, superheated in heat exchanger 3 using the heat from the mixture of nitrogen and hydrogen, and heated almost to the reaction point temperature in HRE coil 8. Ammonia feedstock evaporation in a separate heat exchanger that transfers heat from the mixture of nitrogen and hydrogen means that a simple shell and tube design with evaporation space can be used, the process design is less hardware-intensive, and there is no requirement for multi-stream heat exchangers that feature phase transformation, which could cause high vibration loads and undermine the overall process reliability. The simple shell and tube design also enables an expansion of the process line output by installing as many exchangers in parallel as required for such expansion, which is not possible in the case of a multi-stream heat exchanger seen in the prototype. Furthermore, the use of the nitrogen-hydrogen stream to evaporate and superheat the ammonia feedstock allows to recover more heat from the flue gases, which, in turn, translates into the plant increased energy efficiency as the ammonia feedstock is heated almost to the reaction point temperature meaning lower overall ammonia fuel consumption since less heat is consumed for the ammonia feedstock to reach the reaction point temperature.

The proposed design also differs in that the ammonia fuel is heated in a separate heating medium (preferably, oil type) circuit, and therefore the method and the plant are no longer limited to small-scale applications and can be used in large-scale applications, since using the system of recuperative heat exchangers connected in series separately for the ammonia feedstock stream and the ammonia fuel stream translates into lower unit capacity of individual equipment items on the one hand and higher overall plant capacity on the other hand.

1. A method for producing hydrogen from ammonia, which comprises pressurizing liquid ammonia, heating and evaporating liquid ammonia feedstock, superheating gaseous ammonia feedstock, which is supplied to an ammonia cracking reactor, cooling a mixture of nitrogen and hydrogen resulting from ammonia cracking and recovering hydrogen from the mixture of nitrogen and hydrogen, heating and evaporating liquid ammonia fuel, superheating gaseous ammonia fuel, mixing it with tail gases resulting from the hydrogen recovery, and supplying resulting fuel gas, together with hot air, to the ammonia cracking reactor for combustion, utilizing heat from flue gases to increase temperature of the ammonia feedstock as well as air and fuel gas, wherein the ammonia cracking reactor is used with an outlet for flue gases connected to a heat-reclaiming equipment unit (HRE) that utilizes the heat from flue gases and houses, in a series layout, a gaseous ammonia heating coil, an ammonia fuel heating coil, an air heating coil, a heating medium heating coil, and a liquid ammonia heating coil upstream an HRE flue gas outlet, meanwhile the ammonia feedstock is evaporated and superheated in respective recuperative heat exchangers utilizing the heat from the mixture of nitrogen and hydrogen, and the gaseous ammonia feed is then heated utilizing heat from the flue gases, the ammonia fuel is evaporated and superheated in other respective recuperative heat exchangers using a heating medium that utilizes the heat from the flue gases, and the heat from flue gases is used to increase the temperature of the liquid ammonia feedstock upstream an HRE flue gas outlet, then pressurizing and cooling utilized flue gases, extracting distilled water condensed from the flue gases, and venting dewatered flue gases.

2-3. (canceled)

4. The method according to claim 1, wherein the hydrogen recovery from the mixture of nitrogen and hydrogen is achieved through pressure swing adsorption.

5. The method according to claim 1, that wherein the hydrogen recovery is achieved through membrane recovery.

6. The method according to claim 1, wherein after the liquid ammonia pressurization, the ammonia stream is separated into a liquid ammonia feed stream and a liquid ammonia fuel stream.

7. The method according to claim 1, wherein some of the gaseous ammonia fuel is added to the flue gases supplied to the shell side of the HRE to neutralize nitrogen oxides.

8. A plant for producing hydrogen from ammonia comprising a liquid ammonia pump, an ammonia feedstock heating line, an ammonia fuel heating line, an ammonia cracking reactor paired with a heat-reclaiming equipment unit (HRE), an air heating line and a purification line; the HRE is connected with an ammonia cracking reactor outlet for flue gases and houses, in a series layout, a gaseous ammonia heating coil, an ammonia fuel heating coil, an air heating coil, a heating medium heating coil, and a liquid ammonia heating coil upstream an HRE flue gas outlet; the ammonia feedstock heating line comprises an HRE liquid ammonia feedstock heating coil, the first recuperative heat exchanger, that is an ammonia feedstock evaporator, the second recuperative heat exchanger, that is an ammonia feedstock superheater, and an HRE gaseous ammonia feedstock heating coil, and the ammonia feedstock heating line is connected to reaction tubes of the ammonia cracking reactor; the ammonia fuel heating line comprises the third recuperative heat exchanger-a liquid ammonia fuel heater and the fourth recuperative heat exchanger an ammonia fuel evaporator, which is connected to an HRE gaseous ammonia fuel heating coil connected to an ammonia cracking reactor burner; outlets of the reaction tubes are connected to the second and the first recuperative heat exchangers as well as to the purification line that comprises at least one air cooler and a hydrogen recovery unit, which has a tail gas outlet that is connected to the ammonia fuel heating line upstream the HRE gaseous ammonia fuel heating coil; the air heating line comprises an air supplier and an HRE air heating coil, which is connected to the ammonia cracking reactor burner, moreover, a HRE flue gas outlet is connected in series to a flue gas extractor, at least one other air cooler, and a distilled water separator.

9. The plant according to claim 8, wherein the third recuperative heat exchanger, that is a liquid ammonia fuel heater, and the fourth recuperative heat exchanger, that is an ammonia fuel evaporator, are connected in parallel into a heating medium circuit, which comprises an HRE heating medium heating coil connected to these heat exchangers, and a heating medium circulation pump.

10. The plant according to claim 8, wherein recuperative heat exchangers are the shell and tube type.

11. The plant according to claim 8, wherein the hydrogen recovery unit is a pressure swing adsorption unit.

12. The plant according to claim 8, wherein the hydrogen recovery unit is a membrane hydrogen recovery unit.

13. The plant according to claim 8, wherein the ammonia feedstock heating line and ammonia fuel heating line are connected to a liquid ammonia pump outlet in parallel.

14. The plant according to claim 8, wherein the ammonia fuel heating line has a flue gas branch pipe connected to the HRE shell side.
